(19) United States
(12) Patent Application Publication
(10) Pub. No.: US 2025/0073651 A1
(43) Pub. Date: Mar. 6, 2025

(54) AGITATION DEVICE

(71) Applicant: Honda Motor Co., Ltd., Tokyo (JP)

(72) Inventor: Yoshikazu Yamada, Wako-shi (JP)

(21) Appl. No.: 18/809,307

(22) Filed: Aug. 19, 2024

(30) Foreign Application Priority Data
Sep. 1, 2023 (JP) 2023-142253

(51) Int. Cl. B01F 27/1151; B01F 23/233; B01F 23/2373; B01F 27/93

(52) U.S. Cl. CPC B01F 27/1151; B01F 23/233; B01F 23/2373; B01F 27/93

(57) ABSTRACT

An agitation device includes: an agitation member including a disk of substantially plate shape provided rotatably about a vertical axis in a passage through which liquid and gas flow; and a motor configured to rotationally drive the agitation member. The disk is provided with a plurality of openings to shear the liquid and the gas.

### CROSS-REFERENCE TO RELATED APPLICATION

This application is based upon and claims the benefit of priority from Japanese Patent Application No. 2023-142253 filed on Sep. 1, 2023, the content of which is incorporated herein by reference.

### BACKGROUND OF THE INVENTION

### Field of the Invention

The present invention relates to an agitation device configured to agitate liquid and gas to generate fine bubbles.

### Description of the Related Art

As this type of device, a device configured to generate fine bubbles using a plate-shaped agitation blade is known in the related art. For example, in a device described in JP H5-85498 U, air bubbles are supplied from below to a tank in which a liquid is stored, the air bubbles that have risen are reduced in size to become fine bubbles by a fixed agitation blade, and further the fine bubbles that have risen to the vicinity of a liquid level are pushed downward by a movable agitation blade.

However, it is difficult to efficiently generate fine bubbles only by reducing bubbles in size using a plate-shaped agitation blade as described above.

### SUMMARY OF THE INVENTION

An aspect of the present invention is an agitation device, including: an agitation member including a disk of substantially plate shape provided rotatably about a vertical axis in a passage through which liquid and gas flow; and a motor configured to rotationally drive the agitation member. The disk is provided with a plurality of openings to shear the liquid and the gas.

### BRIEF DESCRIPTION OF THE DRAWINGS

The objects, features, and advantages of the present invention will become clearer from the following description of embodiments in relation to the attached drawings, in which:

FIG. 1 is a cross-sectional view illustrating an example of a reforming reactor and an agitation device according to an embodiment of the present invention;

FIG. 2 is a cross-sectional view of the reforming reactor taken along line II-II in FIG. 1;

FIG. 3 is a cross-sectional view of the reforming reactor taken along line III-III in FIG. 1;

FIG. 4 is a view for describing a reaction flow passage in FIG. 1;

FIG. 5 is a view for describing a heat carrier flow passage in FIG. 1;

FIG. 6 is a view for describing a heat carrier discharging flow passage in FIG. 1;

FIG. 7 is a cross-sectional view for describing a downward flow passage and a return flow passage in FIG. 1;

FIG. 8 is a cross-sectional view for describing the downward flow passage and a reformed fuel discharging flow passage in FIG. 1;

FIG. 9 is a view for describing the downward flow passage in FIG. 1;

FIG. 10 is a perspective view illustrating a partially cut-out lower plate in FIG. 1 from above;

FIG. 11 is a perspective view illustrating the partially cut-out lower plate in FIG. 1 from below;

FIG. 12 is a partially enlarged view of periphery of an agitation member in FIG. 1;

FIG. 13A is a cross-sectional view of a first disk taken along line XIIIA-XIIIA in FIG. 12;

FIG. 13B is a cross-sectional view of a second disk taken along line XIIIB-XIIIB in FIG. 12;

FIG. 13C is a cross-sectional view of a third disk taken along line XIIIC-XIIIC in FIG. 12;

FIG. 13D is a cross-sectional view of a fourth disk taken along line XIIID-XIIID in FIG. 12;

FIG. 14 is a cross-sectional view of the lower plate taken along line XIV-XIV in FIG. 1; and

FIG. 15 is a cross-sectional view of an upper plate taken along line XV-XV in FIG. 1.

### DETAILED DESCRIPTION OF THE INVENTION

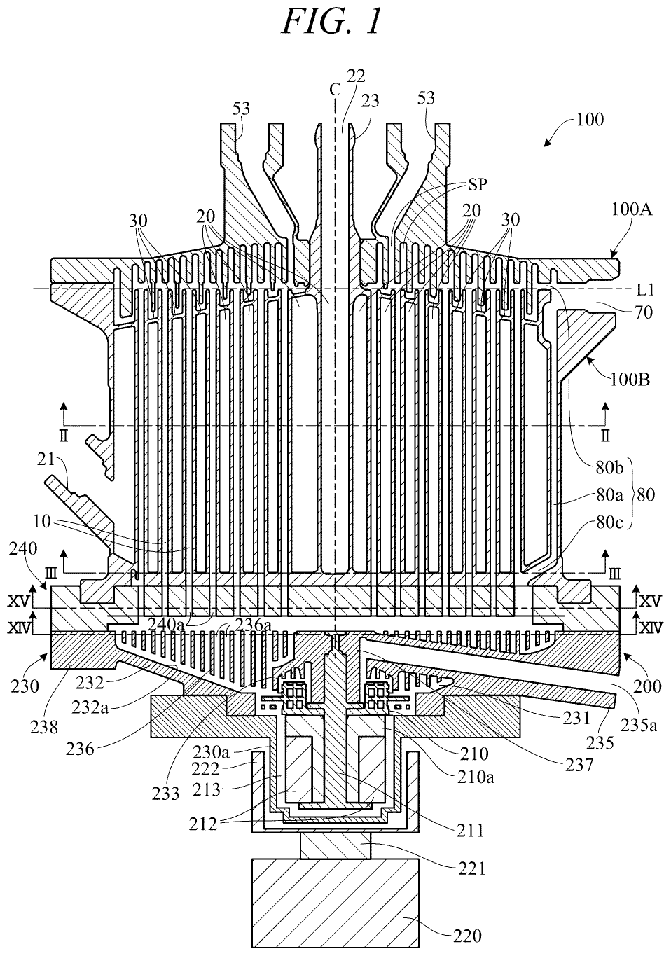

Hereinafter, embodiments of the present invention will be described with reference to FIGS. 1 to 15. An agitation device according to the embodiments of the present invention agitates a liquid and a gas to generate fine bubbles. Hereinafter, in particular, the agitation device that agitates a reaction liquid and a gas to generate fine bubbles and supplies the fine bubbles from below to a reactor that performs a gas-liquid reaction will be described. The reactor is a reforming reactor that is applied to, for example, a compression ignition engine mounted on a vehicle and reforms fuel supplied from a fuel tank to the engine through an oxidation reaction of the fuel.

The average global temperature is maintained in a warm state suitable for living things by greenhouse gases in the atmosphere. To be specific, heat radiated from the ground surface that has been heated by sunlight to outer space is partially absorbed by the greenhouse gases, and is re-radiated to the ground surface, and the atmosphere is maintained in a warm state. Increasing concentrations of greenhouse gases in the atmosphere cause an increase in average global temperature (global warming). Carbon dioxide is a greenhouse gas that greatly contributes to global warming, and its concentration in the atmosphere depends on the balance between carbon fixed on or in the ground in the form of plants or fossil fuels and carbon present in the atmosphere in the form of carbon dioxide. For example, the carbon dioxide in the atmosphere is absorbed through photosynthesis in the growth process of plants, causing a decrease in carbon dioxide concentration in the atmosphere. The carbon dioxide is also released into the atmosphere through combustion of fossil fuels, causing an increase in the carbon dioxide concentration in the atmosphere. In order to mitigate global warming, it is necessary to reduce carbon emissions by replacing fossil fuels with a renewable energy source such as sunlight or wind power, or renewable fuel derived from biomass.

As such a renewable fuel, low-octane gasoline obtained by Fischer-Tropsch (FT) synthesis is becoming widespread. Low-octane gasoline has high ignitability and can be applied to a compression ignition engine. However, low-octane gasoline is still in the stage of becoming widespread and is not yet sold in some areas. On the other hand, regular octane gasoline for a spark ignition engine, which is currently widespread, has low ignitability, and cannot be applied to a compression ignition engine as it is. By placing a reforming reactor in a fuel supply path from a fuel tank to an injector of an engine and reforming the fuel as necessary, both low-octane gasoline and regular octane gasoline can be compression-ignited in a single engine.

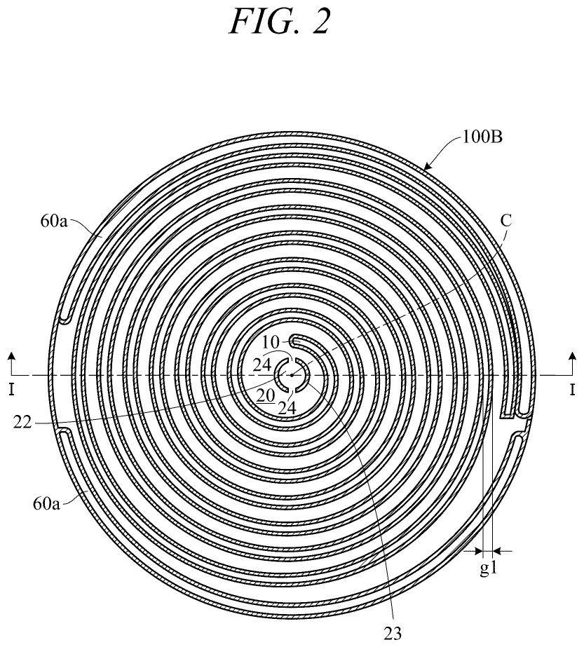

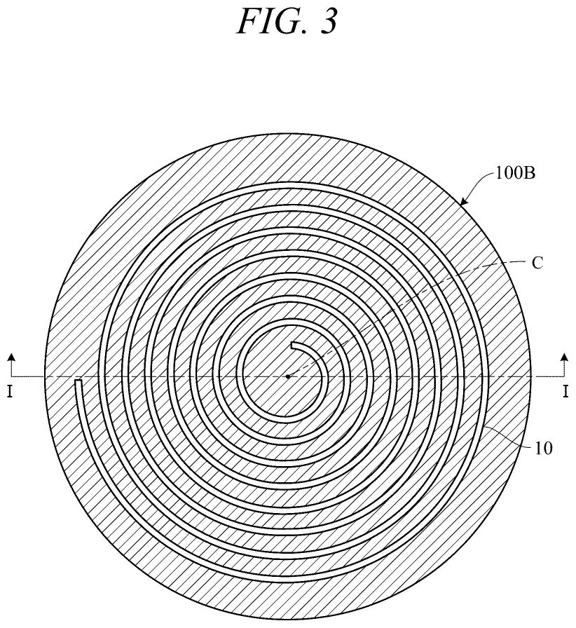

FIG. 1 is a cross-sectional view illustrating an example of a reforming reactor 100 and an agitation device 200 according to an embodiment of the present invention. The agitation device 200 agitates a liquid and a gas to generate fine bubbles. Hereinafter, in particular, an example will be described in which the fuel and the air are agitated to form fine bubbles, and the fuel containing the formed fine bubbles is supplied to the reforming reactor 100. FIG. 2 is a cross-sectional view of the reforming reactor 100 taken along line II-II in FIG. 1. FIG. 3 is a cross-sectional view of the reforming reactor 100 taken along line III-III in FIG. 1. Hereinafter, a direction radially extending from a vertical axis C is defined as a radial direction, and a direction along a circumference of a circle centered on the vertical axis C is defined as a circumferential direction.

As illustrated in FIG. 1, the reforming reactor 100 has an upper piece 100A and a lower piece 100B formed using a metal material having high thermal conductivity. The upper piece 100A and the lower piece 100B can be formed by, for example, additive manufacturing (AM) or the like. As illustrated in FIG. 1, the upper piece 100A and the lower piece 100B are fixed to each other via a seal ring (not illustrated) with a bolt and a nut (not illustrated). In the lower piece 100B of the reforming reactor 100, a reaction flow passage 10 through which fuel circulates and a heat carrier flow passage 20 through which a heat carrier circulates are formed. As illustrated in FIGS. 1 to 3, the reaction flow passage 10 and the heat carrier flow passage 20 are configured to have a band shape to extend in a width direction parallel to the vertical axis C and a length direction perpendicular to the width direction, respectively, and are configured to have a helical or spiral shape centered on the vertical axis C, and are alternately arranged in the radial direction. As illustrated in FIG. 1, an upper end surface and a lower end surface of the reaction flow passage 10 are open, and an upper end surface and a lower end surface of the heat carrier flow passage 20 are closed.

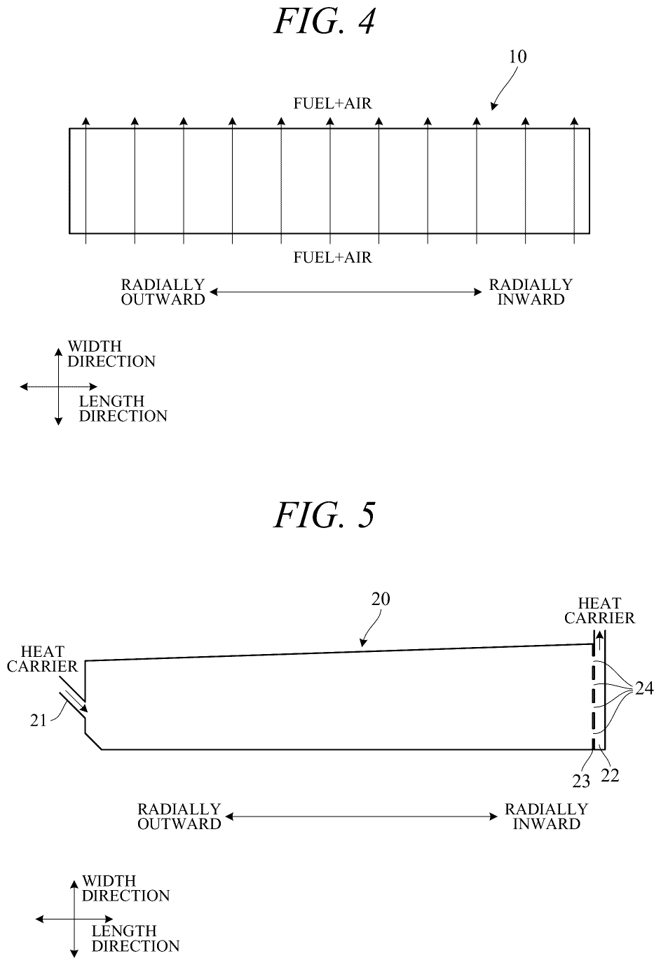

FIG. 4 is a view for describing the reaction flow passage 10. As illustrated in FIGS. 1 and 4, a height of the upper end surface of the reaction flow passage 10 is uniform all over in the radial direction. To the reaction flow passage 10, unreformed fuel containing fine bubbles of air is supplied from below all over in the radial direction by the agitation device 200. The fine bubbles supplied to the reaction flow passage 10 flow to rise in the width direction of the reaction flow passage 10.

A fuel containing hydrocarbons as a main component is oxidatively reformed using a catalyst such as N-hydroxyphthalimide (NHPI) to produce a peroxide, so that ignitability thereof can be improved. Specifically, with NHPI, a hydrogen atom is easily extracted using an oxygen molecule to produce a phthalimide-N-oxyl (PINO) radical. With the PINO radical, a hydrogen atom is extracted from a hydrocarbon (RH) contained in the fuel to produce an alkyl radical (R·). The alkyl radical bonds to an oxygen molecule to produce an alkyl peroxy radical (ROO·). With the alkyl peroxy radical, a hydrogen atom is extracted from a hydrocarbon contained in the fuel to produce an alkyl hydroperoxide (ROOH), which is a peroxide.

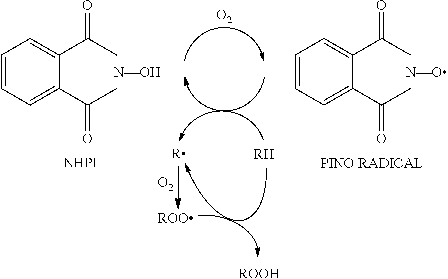

The reaction flow passage 10 functions as a reactor (reaction field) in which the fuel and oxygen in the air react (oxidation reaction, fuel reforming reaction, or a gas-liquid reaction) to generate reformed fuel. In the reaction flow passage 10, a catalyst such as a powdery or wall-supported NHPI catalyst or the like is provided. The fuel supplied to the reaction flow passage 10 and oxygen contained in air (fine bubbles) come into contact with the catalyst provided in the reaction flow passage 10. Consequently, an oxidation reforming reaction of the fuel is promoted all over the reaction flow passage 10 in the radial direction.

As illustrated in FIG. 2, a gap g1 between inner wall surfaces of the reaction flow passage 10, more specifically, between an inner end surface and an outer end surface of the reaction flow passage 10 in the radial direction, is formed to be equal to or smaller than twice a quenching distance. Consequently, since an inner wall surface of the reaction flow passage 10 is always present in a range within the quenching distance from a reactant, the safety of the reforming reactor 100 can be enhanced. In a case where the safety is further enhanced, the reforming reactor 100 may be formed such that the gap g1 equal to or smaller than the maximum safety gap. By configuring the reaction flow passage 10, which is a reaction field in which the oxidation reaction of the fuel proceeds, with the maximum safety gap, for example, the flame is immediately extinguished even in a case where a flame enters from an adjacent device, and thus the safety of the reforming reactor 100 can be further enhanced.

FIG. 5 is a view for describing the heat carrier flow passage 20. As illustrated in FIGS. 1 and 5, the upper end surface of the heat carrier flow passage 20 is formed to be inclined upward toward a radial inner side. In the lower piece 100B of the reforming reactor 100, a heat carrier supplying flow passage 21 for supplying a heat carrier to the vicinity of the lower end of the maximum outer diameter portion of the heat carrier flow passage 20 is formed. The heat carrier supplying flow passage 21 extends to be inclined downward toward the radial inner side to allow the vicinity of the lower end of the maximum outer diameter portion of the heat carrier flow passage 20 to communicate with an external space. Engine cooling water as a heat carrier is supplied from an engine (not illustrated) to the heat carrier flow passage 20 via the heat carrier supplying flow passage 21.

As illustrated in FIGS. 1, 2, and 5, in the lower piece 100B of the reforming reactor 100, a heat carrier discharging flow passage 22 for discharging the heat carrier from the inside diameter portion of the heat carrier flow passage 20 is formed. The heat carrier discharging flow passage 22 protrudes upward from a lower end surface of the heat carrier flow passage 20 and is formed in a columnar shape centered on the vertical axis C. The heat carrier flow passage 20 and the heat carrier discharging flow passage 22 provided in the heat carrier flow passage 20 are separated by a cylindrical partition wall 23.

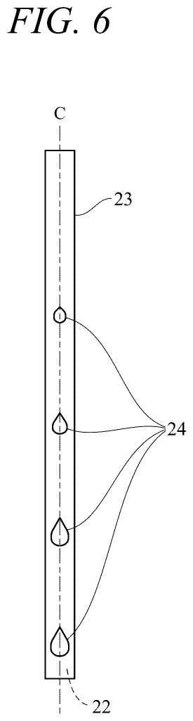

FIG. 6 is a view for describing the heat carrier discharging flow passage 22, and a front view of the partition wall 23. As illustrated in FIGS. 2, 5, and 6, the partition wall 23 is provided with a plurality of (four in the illustrated example) communication holes 24 having different heights from each other from the lower end surface of the heat carrier flow passage 20, and the heat carrier is discharged from the heat carrier flow passage 20 via the communication holes 24 and the heat carrier discharging flow passage 22. The engine cooling water as the heat carrier discharged via the heat carrier discharging flow passage 22 is returned to the engine. The partition wall 23 is formed such that the plurality of communication holes 24 increase in size toward the lower side and decrease in size toward the upper side. The plurality of communication holes 24 are provided at a plurality of locations (two locations in the illustrated example) in the circumferential direction.

As illustrated in FIG. 1, in the lower piece 100B of the reforming reactor 100, a downward flow passage 30 in which the fuel after reforming (reformed fuel) flows is formed above the heat carrier flow passage 20. In other words, the downward flow passage 30 is also formed in a helical or spiral shape centered on the vertical axis C, and is alternately arranged with the reaction flow passage 10 in the radial direction.

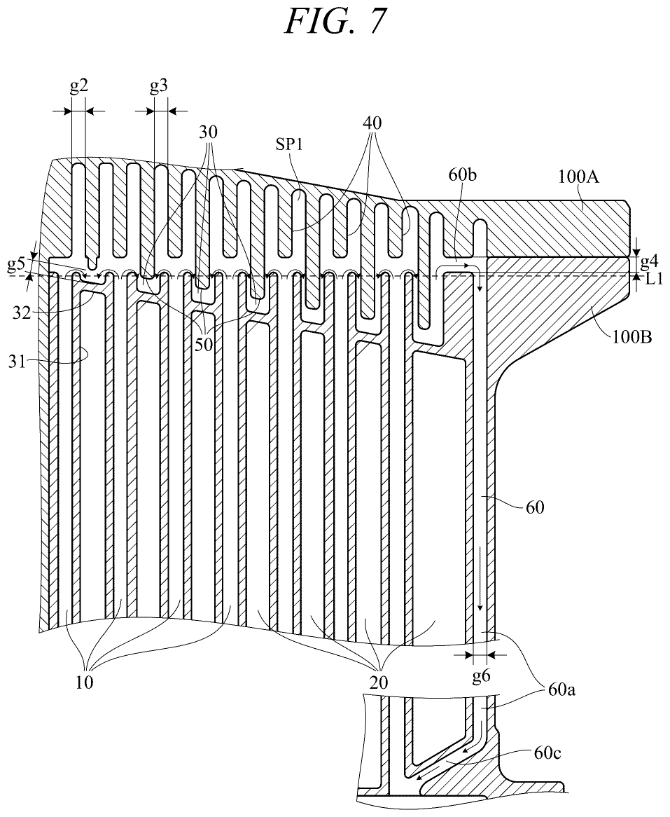

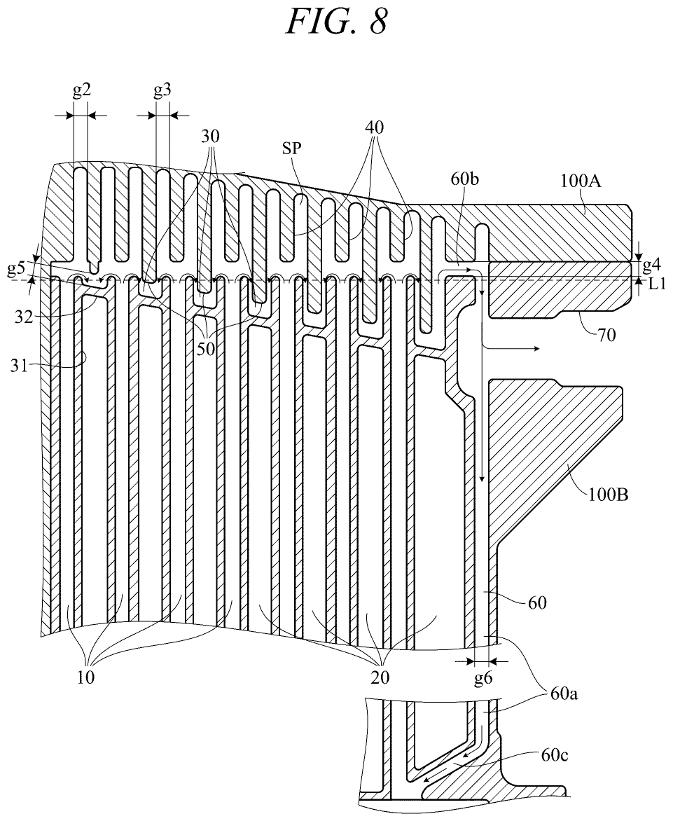

FIGS. 7 and 8 are cross-sectional views for describing the downward flow passage 30. As illustrated in FIGS. 1, 7, and 8, an upper end surface of the downward flow passage 30 is open to communicate with an upper end surface of the reaction flow passage 10. A height of the upper end surface of the reaction flow passage 10 and a height of the upper end surface of the downward flow passage 30 are the same as a height of a partition wall 31 separating the reaction flow passage 10 and the downward flow passage 30 (and the heat carrier flow passage 20), and are the same as each other all over in the radial direction. The heat carrier flow passage 20 and the downward flow passage 30 are separated by a partition wall 32, and a height of the upper end surface of the heat carrier flow passage 20, a height of a lower end surface of the downward flow passage 30, and a height of the partition wall 32 are substantially the same all over in the radial direction. The lower end surface of the downward flow passage 30 is positioned above the lower end surfaces of the reaction flow passage 10 and the heat carrier flow passage 20 all over in the radial direction, and is formed to be inclined downward toward a radial outer side.

The upper piece 100A of the reforming reactor 100 has a first projecting portion 40 and a second projecting portion 50 formed to project downward from an inner wall surface on an upper side of the upper piece. The first projecting portion 40 is formed corresponding to the reaction flow passage 10 and projects from the inner wall surface above the reaction flow passage 10 toward the reaction flow passage 10 all over in the radial direction. The second projecting portion 50 is formed corresponding to the downward flow passage 30 (and the heat carrier flow passage 20) and projects from the inner wall surface above the downward flow passage 30 toward the downward flow passage 30 all over in the radial direction.

As illustrated in FIGS. 7 and 8, a gap g2 between the first projecting portion 40 and the second projecting portion 50, more specifically, between an outer end surface of the first projecting portion 40 and an inner end surface of the second projecting portion 50 in the radial direction, is also formed to be equal to or smaller than twice the quenching distance or equal to or smaller than the maximum safety gap. Similarly, a gap g3 between an outer end surface of the second projecting portion 50 and an inner end surface of the first projecting portion 40 is also formed to be equal to or smaller than twice the quenching distance or equal to or smaller than the maximum safety gap. Furthermore, a gap g4 between the upper end surface of the reaction flow passage 10 and a lower end surface of the first projecting portion 40 and a gap g5 between the lower end surface of the downward flow passage 30 and a lower end surface of the second projecting portion 50 are also formed to be equal to or smaller than twice the quenching distance or equal to or smaller than the maximum safety gap.

A liquid level (gas-liquid separation surface) L1 of the reformed fuel is adjusted to be located between the upper end surface of the reaction flow passage 10 and the downward flow passage 30 and the lower end surface of the first projecting portion 40. A space (gas-liquid separation space) SP1 from the gas-liquid separation surface L1 to the inner wall surface on the upper side of the upper piece 100A has a helical or spiral labyrinth shape due to the first projecting portion 40 and the second projecting portion 50. As illustrated in FIG. 1, in the upper piece 100A of the reforming reactor 100, a gas discharging flow passage 33 for discharging the gas from the reaction flow passage 10 is formed. The gas discharging flow passage 33 communicates with the reaction flow passage 10 via the gas-liquid separation space SP1. The air supplied to the reaction flow passage 10 rises in the reaction flow passage 10 to be subjected to the reforming reaction, is then released from the gas-liquid separation surface L1 into the gas-liquid separation space SP1, and is discharged to the external space via the gas discharging flow passage 33 after the liquid is separated in the gas-liquid separation space SP1. The air discharged via the gas discharging flow passage 33 is supplied to an intake port of the engine and sucked into a combustion chamber of the engine together with fresh air.

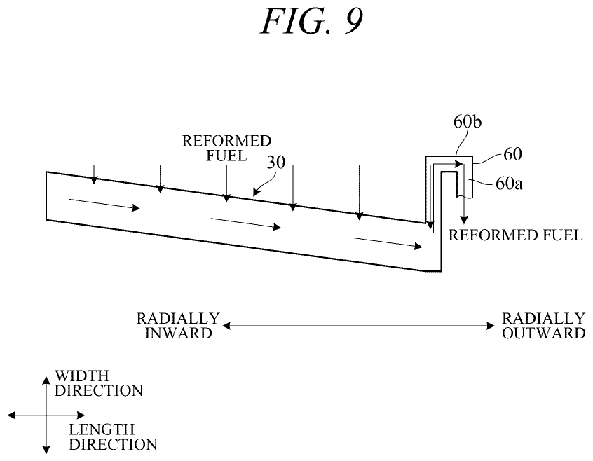

FIG. 9 is a view for describing the downward flow passage 30. As illustrated in FIGS. 1 and 7 to 9, the lower end surface of the downward flow passage 30 is formed to be inclined downward toward the radial outer side. As illustrated in FIGS. 1, 2, and 7 to 9, in the lower piece 100B of the reforming reactor 100, a return flow passage 60 for allowing the reformed fuel to be returned to the lower end of the maximum outer diameter portion of the reaction flow passage 10 is formed. As illustrated in FIGS. 7 and 8, a gap g6 between inner wall surfaces of the return flow passage 60, more specifically, between an inner end surface and an outer end surface of the return flow passage 60 in the radial direction, is also formed to be equal to or smaller than twice the quenching distance or equal to or smaller than the maximum safety gap.

As illustrated in FIGS. 1, 2, and 7 to 9, the return flow passage 60 includes a vertical flow passage 60a, a horizontal flow passage 60b, and an inclined flow passage 60c. The vertical flow passage 60a extends in a vertical direction from the vicinity of an upper end to the vicinity of a lower end of the lower piece 100B on a side further outward from the maximum outer diameter portions of the reaction flow passage 10 and the heat carrier flow passage 20, that is, the maximum outer diameter portion of the partition wall 31. The horizontal flow passage 60b extends in a horizontal direction on the upper end surface of the maximum outer diameter portion of the partition wall 31 to allow the maximum outer diameter portion of the downward flow passage 30 to communicate with an upper end surface of the vertical flow passage 60a. The inclined flow passage 60c extends to be inclined downward toward the radial inner side to allow a lower end of the vertical flow passage 60a to communicate with the lower end of the maximum outer diameter portion of the reaction flow passage 10.

As illustrated in FIGS. 1 and 8, in the lower piece 100B of the reforming reactor 100, a reformed fuel discharging flow passage 70 for discharging a part of the reformed fuel from the maximum outer diameter portion of the downward flow passage 30 is formed. The reformed fuel discharging flow passage 70 extends in the horizontal direction near an upper end of the return flow passage 60, more specifically, at a position slightly lower than the horizontal flow passage 60b, to allow the vertical flow passage 60a to communicate with the external space.

As illustrated in FIGS. 4 and 7 to 9, the reformed fuel which is reformed while flowing upward in the width direction of the reaction flow passage 10 overflows from the upper end surface of the reaction flow passage 10, flows into the downward flow passage 30 beyond the partition wall 31, and flows radially outward in the length direction of the downward flow passage 30. A part of the reformed fuel that has reached the maximum outer diameter portion of the downward flow passage 30 is discharged via the reformed fuel discharging flow passage 70, and the rest thereof is returned to the lower end of the maximum outer diameter portion of the reaction flow passage 10 via the return flow passage 60.

In order to improve a reforming rate in the reaction flow passage 10 of the reforming reactor 100 described above, that is, a reaction rate of the gas-liquid reaction, it is necessary to supply fuel (liquid) sufficiently containing fine bubbles to the reaction flow passage 10. As a technique of supplying the liquid containing fine bubbles, a technique of generating fine bubbles by supplying gas into the liquid via a filter made of a porous material such as a sintered body or a foam is also known. However, in this technique, when the filter has gaps or a portion in which non-uniform pores are provided, large bubbles are preferentially generated from the large pores or gaps, and thus it is difficult to generate sufficient fine bubbles. In particular, when a volume of the filter increases, effects of gaps or a portion in which non-uniform pores are provided become large, and thus it is difficult to generate fine bubbles with a sufficient flow rate.

As a technique without using a filter, a technique of swirling a liquid at high speed and generating fine bubbles due to shearing with a swirling flow, a technique of generating fine bubbles due to cavitation by rapidly contracting and expanding a flow passage, and the like are known. However, these techniques are based on the premise that the flow rate of the liquid is relatively large, and it is difficult to apply these techniques in the case of a relatively low flow rate of a liquid, such as a fuel flow rate according to a required output of an engine. Thus, in this embodiment, the agitation device 200 is configured as follows so that fuel (liquid) sufficiently containing fine bubbles can be supplied to the reforming reactor 100 by efficiently generating fine bubbles by agitation even in the case of the relatively low flow rate.

As illustrated in FIG. 1, the agitation device 200 mainly includes an agitation member 210, a motor 220 that rotationally drives the agitation member 210, a lower plate 230 that accommodates the agitation member 210, and an upper plate 240 interposed between the lower plate 230 and the reforming reactor 100.

The agitation member 210 is disposed in a passage 231 formed in the lower plate 230 in which a liquid and gas circulate to be rotatable about the vertical axis C, is connected to the motor 220 by so-called magnet coupling, and is rotationally driven in a non-contact manner.

More specifically, a shaft portion 211 having a substantially columnar shape centered on the vertical axis C is fixed to the lower plate 230 by press fitting or the like so as not to be relatively rotatable. The agitation member 210 is provided on an outer circumferential surface of the shaft portion 211 to be relatively rotatable with respect to the shaft portion 211, and a spacer 210a is provided below the agitation member 210 to be relatively rotatable with respect to the shaft portion 211. An undersurface of the agitation member 210 and an upper surface of the spacer 210a are provided with unevenness, and thereby the agitation member 210 and the spacer 210a are fixed so as not to be relatively rotatable. An inner magnet 212 is fixed to an outer circumferential surface of the spacer 210a so as not to be relatively rotatable with respect to the spacer 210a. The spacer 210a and the inner magnet 212 are restricted from moving in an up-down direction by a lower end portion of the shaft portion 211. Below the lower plate 230, a partition wall portion 230a forming an accommodation chamber 213 which accommodates the shaft portion 211 below the agitation member 210, the spacer 210a, and the inner magnet 212 is provided. The partition wall portion 230a is fixed to, for example, an undersurface of the lower plate 230. The accommodation chamber 213 communicates with the passage 231 of the lower plate 230. The accommodation chamber 213 is filled with a liquid flowing from the passage 231 of the lower plate 230.

A cylindrical outer magnet 222 is fixed to an output shaft of the motor 220 via a motor joint 221 and rotates integrally with the output shaft of the motor 220. The outer magnet 222 is disposed on an outer diameter side of the accommodation chamber 213 to surround the accommodation chamber 213 (the partition wall portion 230a). A space in which the motor 220 and the like are accommodated is filled with an inert gas such as nitrogen gas, and safety is secured.

When the motor 220 rotates, the outer magnet 222 rotates integrally with the motor 220. When the outer magnet 222 rotates, the inner magnet 212, the spacer 210a, and the agitation member 210 integrally rotate about the vertical axis C in the liquid in the accommodation chamber 213 by the attractive force and the repulsive force.

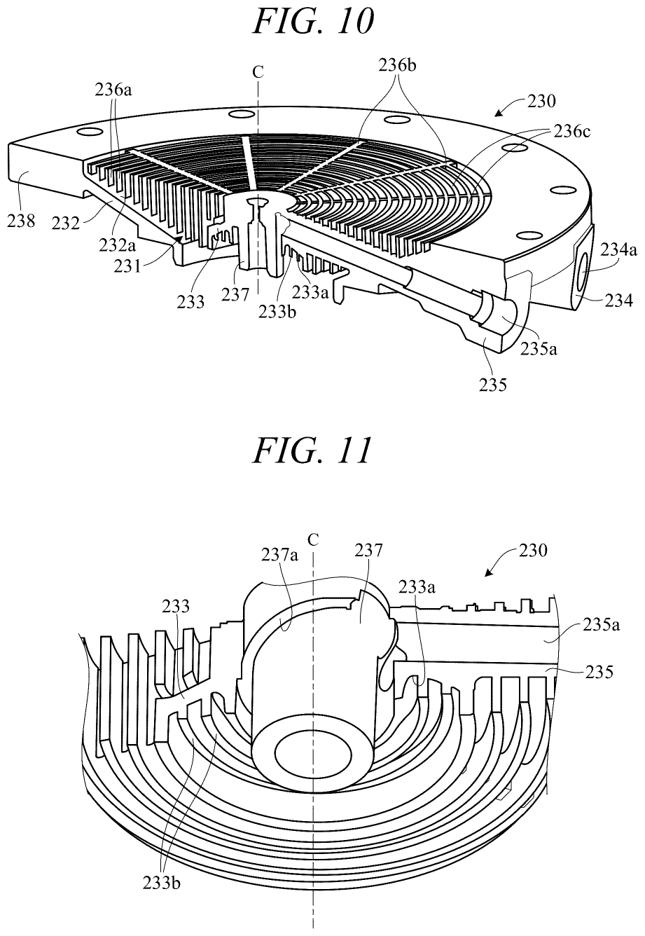

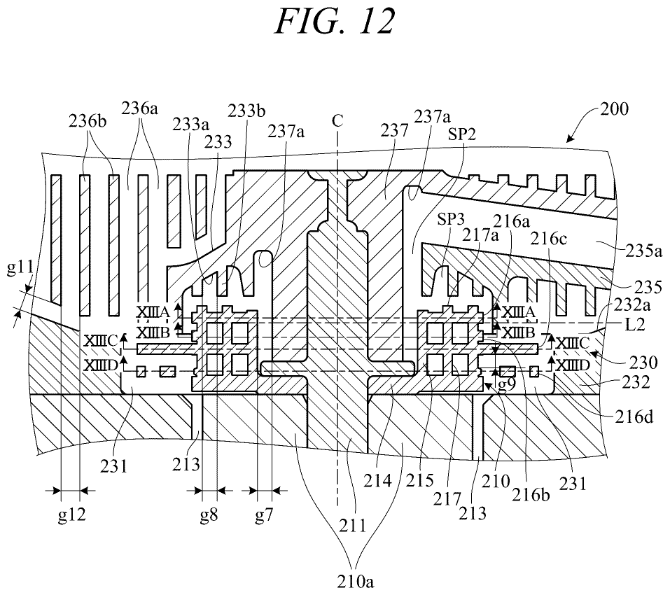

FIG. 10 is a perspective view illustrating the partially cut-out lower plate 230 from above. FIG. 11 is a perspective view illustrating the partially cut-out lower plate 230 from below. FIG. 12 is a partially enlarged view of the periphery of the agitation member 210 in FIG. 1. As illustrated in FIGS. 1 and 10, the lower plate 230 includes a case portion 232, a cover portion 233, a liquid supplying flow passage forming portion 234, a gas supplying flow passage forming portion 235, an annular flow passage forming portion 236, a cylindrical portion 237, and an annular portion 238.

As illustrated in FIGS. 1 and 12, the cylindrical portion 237 is formed in a substantially cylindrical shape centered on the vertical axis C to accommodate the vicinity of an upper end of the shaft portion 211. The annular portion 238 is formed in a substantially annular shape centered on the vertical axis C. The annular portion 238 of the lower plate 230 is fixed to the upper plate 240 via a seal ring (not illustrated) with a bolt and a nut (not illustrated).

As illustrated in FIGS. 1, 10, and 12, the case portion 232 forms a conical surface 232a centered on the vertical axis C, which faces the passage 231 and extends radially outward at an upward inclination to the inner circumferential surface of the annular portion 238 around the agitation member 210.

As illustrated in FIGS. 1, 10, 11, and 12, the cover portion 233 is formed in a substantially annular shape in plan view centered on the vertical axis C and extends downward from an outer circumferential surface of the cylindrical portion 237 toward the outer diameter side to cover an upper surface of the agitation member 210. An undersurface 233a of the cover portion 233 is formed in a concave shape to face the upper surface of the agitation member 210. The cover portion 233 has a projecting portion 233b projecting downward from the undersurface 233a toward the upper surface of the agitation member 210.

The liquid supplying flow passage forming portion 234 forms a liquid supplying flow passage 234a through which a liquid (fuel) is supplied to the passage 231. The liquid supplying flow passage 234a extends to be inclined upward toward the radial inner side to allow the passage 231 to communicate with the external space. The gas supplying flow passage forming portion 235 forms a gas supplying flow passage 235a through which gas (air) is supplied to the passage 231. The gas supplying flow passage 235a also extends to be inclined upward toward the radial inner side to allow the passage 231 to communicate with the external space. The unreformed fuel is supplied to the passage 231 from a fuel pump (not illustrated) via the liquid supplying flow passage 234a, and the air is supplied from an air pump (not illustrated) via the gas supplying flow passage 235a.

As illustrated in FIG. 12, the gas supplying flow passage 235a communicates with a space (reservoir space) SP3 between the upper surface of the agitation member 210 and the cover portion 233, via a substantially cylindrical space (cylindrical space) SP2 along the outer circumferential surface of the cylindrical portion 237. Similarly, the liquid supplying flow passage 234a also communicates with the reservoir space SP3 via the cylindrical space SP2. As illustrated in FIGS. 11 and 12, a spiral groove 237a is formed in the outer circumferential surface of the cylindrical portion 237 such that a height of the cylindrical space SP2 is spirally lowered in a rotation direction of the motor 220 (in the illustrated example, clockwise in a top view) from the position where the liquid supplying flow passage 234a communicates with the gas supplying flow passage 235a. In other words, the uppermost portion of the cylindrical space SP2 through which the liquid supplying flow passage 234a communicates with the gas supplying flow passage 235a is a starting point or the uppermost stream of the passage 231. More specifically, the liquid supplying flow passage 234a communicates with the cylindrical space SP2 at the uppermost stream of the passage 231, and the gas supplying flow passage 235a communicates with the cylindrical space SP2 immediately downstream thereof.

As illustrated in FIG. 12, the agitation member 210 includes a base portion 214, a guide portion 215, a plurality of (four in the illustrated example) disk portions 216a to 216d, and a plurality of columnar portions 217. The base portion 214 is formed in a substantially plate shape and an annular shape centered on the vertical axis C, and the agitation member 210 is disposed such that the inner circumferential surface of the base portion 214 faces the outer circumferential surface of the shaft portion 211. At least a part of an undersurface of the base portion 214 is provided with unevenness, and the unevenness of the undersurface of the base portion 214 is fitted to the unevenness of the upper surface of the spacer 210a, so that the agitation member 210 and the spacer 210a are fixed so as not to be relatively rotatable and integrally rotate. The guide portion 215 extends in a cylindrical shape upward from the upper surface of the base portion 214 on the outer diameter side of the cylindrical portion 237.

The disk portions 216a to 216d extend horizontally toward the outer diameter side from an outer circumferential surface of the guide portion 215. The disk portions 216a to 216d are provided in a plurality of tiers (four tiers in the illustrated example) in the up-down direction. Diameters of the disk portions 216a and 216b in the two top tiers are smaller than diameters of the disk portions 216c and 216d in the two bottom tiers. The plurality of columnar portions 217 protrude upward from the upper surface of the base portion 214 to connect the plurality of tiers of disk portions 216a to 216d on the outer diameter side of the cylindrical portion 237. The columnar portion 217 projects upward from an upper surface of the uppermost disk portion 216a. A liquid level L2 of fuel supplied to the passage 231 is adjusted to be located in the vicinity of an undersurface of the uppermost disk portion 216a and at least below the upper surface of the uppermost disk portion 216a.

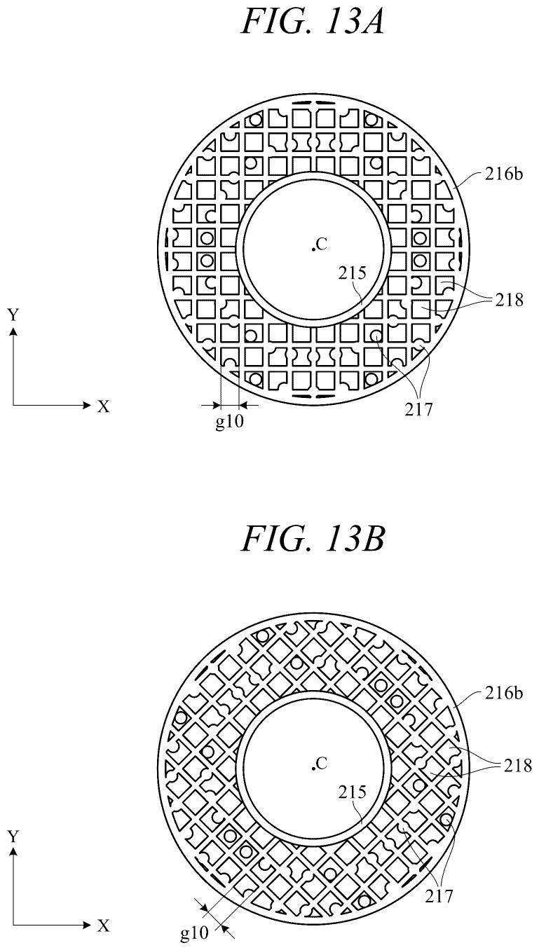

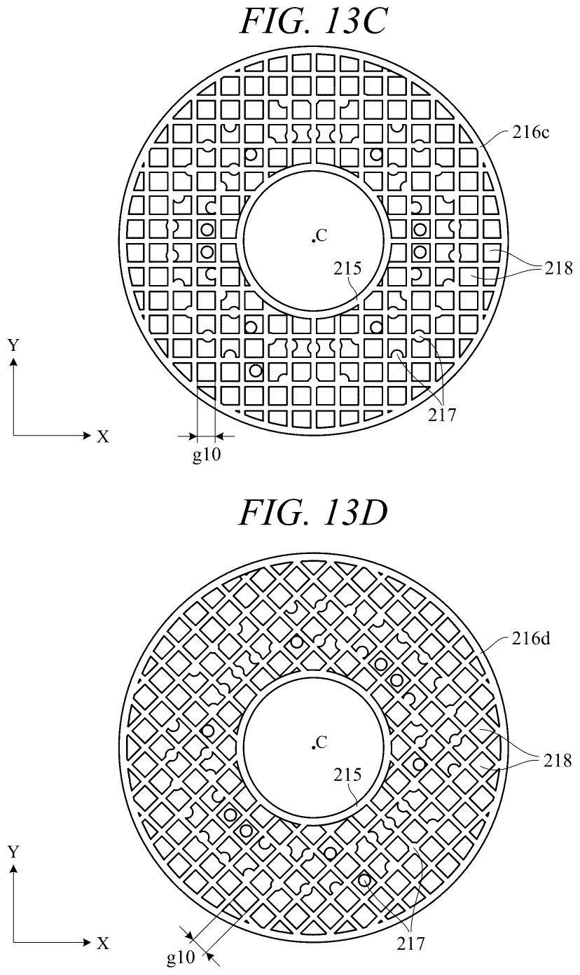

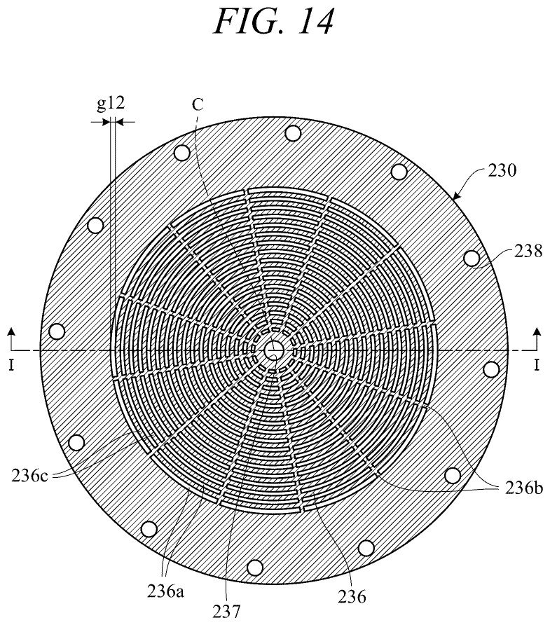

FIG. 13A is a cross-sectional view of the disk portion 216 taken along line XIIIA-XIIIA in FIG. 12. FIG. 13B is a cross-sectional view of the disk portion 216 taken along line XIIIB-XIIIB in FIG. 12. FIG. 13C is a cross-sectional view of the disk portion 216 taken along line XIIIC-XIIIC in FIG. 12. FIG. 13D is a cross-sectional view of the disk portion 216 taken along line XIIID-XIIID in FIG. 12. As illustrated in FIGS. 13A to 13D, a plurality of openings 218 are provided in each of the disk portions 216a to 216d to shear a liquid and gas, respectively. More specifically, the plurality of openings 218 are provided in a grid shape in each of the disk portions 216a to 216d.

Grids of the disk portions 216a and 216c are defined by a plurality of straight lines extending in a first direction (an X-axis direction in the illustrated example) and a plurality of straight lines extending in a second direction (a Y-axis direction in the illustrated example) orthogonal to the first direction. The grids are defined by a plurality of straight lines extending in a third direction different from both the first direction and the second direction and a plurality of straight lines extending in a fourth direction orthogonal to the third direction. In other words, the third direction intersects each of the first direction and the second direction at an angle larger than 0 degrees and smaller than 90 degrees, for example, 45 degrees, in plan view. In other words, the plurality of disk portions 216a to 216d are arranged such that phases of the openings 218 of the disk portions 216a and 216b, the disk portions 216b and 216c, and the disk portions 216c and 216d facing each other are shifted.

The fuel and air supplied to the cylindrical space SP2 via the liquid supplying flow passage 234a and the gas supplying flow passage 235a descend spirally in the rotation direction of the motor 220 along the groove 237a and flow into the reservoir space SP3 above the uppermost disk portion 216a. The fuel and the air flowing into the reservoir space SP3 are circumvoluted by the columnar portions 217 projecting upward from the uppermost disk portion 216a of the agitation member 210 rotating in the rotation direction of the motor 220 and the openings 218 of the uppermost disk portion 216a and are drawn into the agitation member 210. As described above, the uppermost disk portion 216a is disposed above the liquid level L2, and the plurality of columnar portions 217 project upward, so that the air reserved in the reservoir space SP3 can efficiently be drawn into the agitation member 210.

The fuel and the air drawn into the agitation member 210 flow downward along the outer circumferential surface of the guide portion 215 and flow toward the outer diameter side by the centrifugal force of rotation, and are sheared and agitated by end portions (angular cross sections or edges) of the plurality of openings 218, thereby generating fine bubbles. More specifically, the plurality of openings 218 having the grid shape are provided in the plurality of disk portions 216a to 216d, and the plurality of openings 218 are formed such that horizontal cross sections (FIGS. 13A to 13D) and a vertical cross section (FIG. 12) of the disk portions 216a to 216d have a plurality of angular cross sections. As described above, when the agitation member 210 is formed into a shape having many angular cross sections, fine bubbles can be efficiently generated. In this case, for example, as compared with a case where a wire or the like is bent to form a shape having many round cross sections, fine bubbles can be generated at a relatively small times of rotation, and agitation resistance and energy consumption can be reduced. Furthermore, it is possible to reduce a flow velocity of the fuel and the air supplied to the reforming reactor 100 so as not be too high. Furthermore, by shifting the phases of the openings 218 of the facing disk portions 216a to 216d, a turbulent flow is generated between the facing disk portions 216a to 216d, so that fine bubbles can be generated more efficiently.

FIG. 14 is a cross-sectional view of the lower plate 230 taken along line XIV-XIV in FIG. 1. As illustrated in FIGS. 10, 12, and 14, the annular flow passage forming portion 236 forms a plurality of annular flow passages 236a concentrically about the vertical axis C above the case portion 232 and on a radial outer side of the cover portion 233, from the outer circumferential surface of the cylindrical portion 237 to the inner circumferential surface of the annular portion 238. More specifically, as illustrated in FIG. 14, the annular flow passage forming portion 236 includes a plurality of radial portions 236b radially extending from the outer circumferential surface of the cylindrical portion 237 to the inner circumferential surface of the annular portion 238, and a plurality of annular portions 236c provided concentrically about the vertical axis C. The plurality of annular portions 236c are connected to each other via the plurality of radial portions 236b and are connected to the outer circumferential surface of the cylindrical portion 237 and the inner circumferential surface of the annular portion 238.

As illustrated in FIGS. 10 and 12, the annular portion 236c extends in the vertical direction from an upper surface of the lower plate 230 to above the case portion 232. The annular flow passage 236a is formed between the annular portions 236c facing each other, that is, between an inner circumferential surface and an outer circumferential surface thereof. A lower end surface of the annular portion 236c is positioned above the upper surface (the conical surface 232a) of the case portion 232.

The fuel containing the fine bubbles generated by the agitation member 210 flows to the outer diameter side due to the centrifugal force of rotation and is discharged radially outward from below the cover portion 233. The fuel containing the fine bubbles discharged radially outward from below the cover portion 233 flows to the maximum outer diameter portion along the conical surface 232a due to the centrifugal force of rotation, flows upward along the annular flow passage 236a, and is straightened. Consequently, the fuel containing the fine bubbles can uniformly circulate all over in the radial direction. Furthermore, the turbulent flow generated by the agitation in the agitation member 210 is attenuated by being straightened, and a flow velocity of the fuel containing the fine bubbles flowing upward can be reduced.

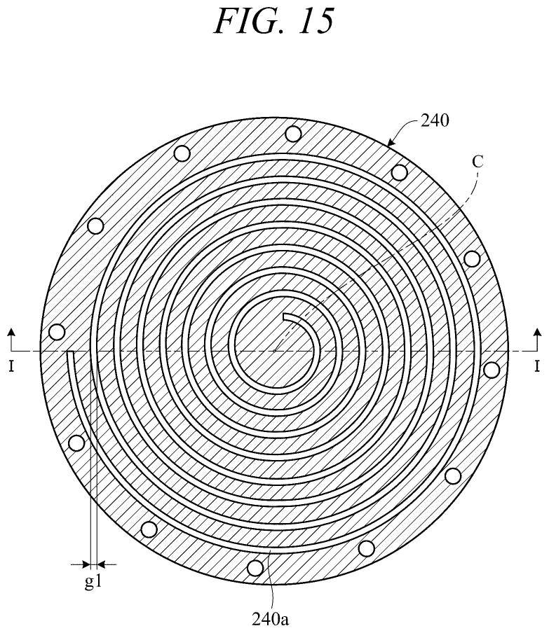

FIG. 15 is a cross-sectional view of the upper plate 240 taken along line XV-XV in FIG. 1. As illustrated in FIGS. 1 to 3 and 15, in the upper plate 240, a helical or spiral flow passage 240a having a helical or spiral shape centered on the vertical axis C is formed corresponding to the reaction flow passage 10 of the reforming reactor 100. As illustrated in FIGS. 1, 14, and 15, the fuel containing the fine bubbles flowing out from an upper end of the annular flow passage 236a is collected and flows into the helical or spiral flow passage 240a of the upper plate 240. The fuel containing the fine bubbles which has flowed into the helical or spiral flow passage 240a flows upward along the helical or spiral flow passage 240a and is further straightened such that the turbulent flow generated by the agitation in the agitation member 210 is further attenuated, and then the fuel flows into the reaction flow passage 10 of the reforming reactor 100. The rotation directions of the motor 220 and the agitation member 210 are determined such that the fuel containing the fine bubbles flows to the inner diameter side in the helical or spiral flow passage 240a.

As illustrated in FIGS. 12 to 15, a gap g7 of the cylindrical space SP2, a gap g8 between the projecting portions 233b of the cover portion 233, a gap g9 between the facing disk portions 216a to 216d, a gap g10 of each opening 218, a gap g11 between the conical surface 232a of the case portion 232 and the lower end surface of the annular portion 236c, a gap g12 of the annular flow passage 236a, and the gap g1 of the helical or spiral flow passage 240a are all formed to be equal to or smaller than twice the quenching distance or equal to or smaller than the maximum safety gap. As described above, all the gaps g1 and g7 to g12 in the passage 231 through which the fuel and the air flow are formed to be equal to or smaller than twice the quenching distance or equal to or smaller than the maximum safety gap, and thereby it is possible to increase a size of the agitation device 200 as necessary while ensuring the safety of the agitation device. More specifically, by increasing the number of tiers and the diameter of the disk portions 216 of the agitation member 210, a necessary amount of fine bubbles can be generated and supplied to the reforming reactor 100 and the like.

In a case where the fine bubbles are generated using the agitation device 200 and the fuel containing the fine bubbles is supplied to the reforming reactor 100, it is possible to generate sufficient fine bubbles regardless of the fuel flow rate by appropriately changing other parameters while adjusting the fuel flow rate required on the reforming reactor 100 side. For example, the shape of the agitation member 210, the rotation speed of the motor 220, the supply flow rate of air, and the like can be changed as necessary.

According to this embodiment, the following operations and effects can be achieved.
(1) The agitation device 200 includes the agitation member 210 having substantially plate-shaped disk portions 216a to 216d provided rotatably about the vertical axis C in the passage 231 through which the liquid and the gas flow, and the motor 220 that rotationally drives the agitation member 210 (FIG. 1). The disk portions 216a to 216d are provided with the plurality of openings 218 to shear the liquid and the gas (FIGS. 13A to 13D). The end portions of the disk portions 216a to 216d which are in contact with the liquid and the end portions of the plurality of openings 218 shear the liquid and the gas, so that the fine bubbles can be efficiently generated.
(2) The plurality of openings 218 are provided in the grid shape (FIGS. 13A to 13D). In this case, the end portions of each opening 218, that is, the plurality of corner portions (four corner portions on each of front and back surfaces in the illustrated example) of the grid, can more efficiently shear the liquid and the gas to generate the fine bubbles more efficiently.
(3) The plurality of openings 218 are formed such that the horizontal cross sections and the vertical cross sections of the disk portions 216a to 216d have a plurality of angular cross sections (FIGS. 12 and 13A to 13D). In this case, the end portions of each opening 218, that is, a plurality of sides (four sides on each of the front and back surfaces in the illustrated example) of the grid can more efficiently shear the liquid and the gas to generate the fine bubbles more efficiently.
(4) Each of the disk portions 216 has a columnar portion 217 projecting upward (FIGS. 1 and 12). Consequently, efficient drawing of the gas reserved in the passage 231 above the disk portions 216 enables the liquid and the gas to be more efficiently sheared and the fine bubbles to be more efficiently generated.
(5) The agitation member 210 includes the disk portions 216a and 216c, and the disk portions 216b and 216d disposed to face the disk portions 216a and 216c (FIGS. 1 and 12). Each of the disk portions 216a and 216c and the disk portions 216b and 216d has the plurality of openings 218 to shear the liquid and the gas (FIGS. 1 and 12). Consequently, the liquid and the gas can be more efficiently sheared, and the fine bubbles can be more efficiently generated.
(6) The agitation member 210 includes the disk portions 216a and 216c, and the disk portions 216b and 216d disposed to face the disk portions 216a and 216c (FIGS. 1 and 12). Each of the disk portions 216a and 216c has the plurality of openings 218 having the grid shape defined by the plurality of straight lines extending in the first direction (X-axis direction) and the plurality of straight lines extending in the second direction (Y-axis direction) orthogonal to the first direction to shear the liquid and the gas (FIGS. 13A and 13C). Each of the disk portions 216b and 216d has the plurality of openings 218 having the grid shape defined by the plurality of straight lines extending in the third direction and the plurality of straight lines extending in the fourth direction orthogonal to the third direction to shear the liquid and the gas (FIGS. 13B and 13D). The first straight line and the third straight line intersect each other at about 45 degrees in plan view (FIGS. 13A to 13D). Consequently, the turbulent flow is generated between the openings 218 of the disk portions 216a and 216c and the disk portions 216a and 216c facing each other, and thereby the fine bubbles can be generated more efficiently.
(7) The agitation member 210 has the plurality of tiers of disk portions 216a to 216d in the up-down direction (FIGS. 1 and 12). Of the plurality of tiers of disk portions 216a to 216d, the diameter of the uppermost disk portion 216a is smaller than the diameter of the lowermost disk portion 216d (FIGS. 13A and 13D). Consequently, the gas reserved in the passage 231 above the uppermost disk portion 216a is drawn efficiently, the liquid and the gas can be sheared more efficiently, and the fine bubbles can be generated more efficiently.
(8) The agitation device 200 further includes the case portion 232 that forms the conical surface 232a centered on the vertical axis C around the agitation member 210, the conical surface 232a facing the passage 231 and extending upward toward the radial outer side with the vertical axis C as the center, the cover portion 233 having a substantially annular shape centered on the vertical axis C in plan view, the cover portion 233 covering the upper surfaces of the disk portions 216a to 216d and having the undersurface 233a formed in a recessed shape facing the upper surfaces of the disk portions 216a to 216d, the annular flow passage forming portion 236 that forms the plurality of annular flow passages 236a concentrically about the vertical axis C above the case portion 232 and on the radial outer side of the cover portion 233 centered on the vertical axis C, and the liquid supplying flow passage forming portion 234 forming the liquid supplying flow passage 234a through which the liquid is supplied to the passage 231 between the disk portions 216a to 216d and the cover portion 233 and the gas supplying flow passage forming portion 235 forming the gas supplying flow passage 235a through which the gas is supplied (FIGS. 1, 10 to 12, and 14).

As illustrated in FIG. 12, the gas reserved on the undersurface 233a of the cover portion 233 of the passage 231 is drawn into the agitation member 210 from the upper surfaces of the disk portions 216a to 216d. The liquid and the gas drawn into the agitation member 210 are sheared by the plurality of openings 218 in the grid shape having phases different from each other, and the fine bubbles are generated. The fine bubbles generated by the agitation member 210 are discharged toward a side further outward from the cover portion 233 due to the centrifugal force of the rotation of the agitation member 210. The fine bubbles discharged toward the side further outward from the cover portion 233 flow toward the outer diameter side along the conical surface 232a of the case portion 232 due to the centrifugal force and flow upward along the annular flow passage 236a. Consequently, the fine bubbles can be uniformly dispersed all over in the radial direction.

In the above embodiments, the example has been described in which the agitation device 200 is applied to the reforming reactor 100, but the agitation device may be any device as long as the device agitates a liquid and gas to generate fine bubbles, and is not limited to the example.

The above embodiment can be combined as desired with one or more of the aforesaid modifications. The modifications can also be combined with one another.

According to the present invention, it becomes possible to efficiently generate fine bubbles.

Above, while the present invention has been described with reference to the preferred embodiments thereof, it will be understood, by those skilled in the art, that various changes and modifications may be made thereto without departing from the scope of the appended claims.

1. An agitation device, comprising:
an agitation member including a disk of substantially plate shape provided rotatably about a vertical axis in a passage through which liquid and gas flow; and
a motor configured to rotationally drive the agitation member, wherein
the disk is provided with a plurality of openings to shear the liquid and the gas.

2. The agitation device according to claim 1, wherein
the plurality of openings is provided in grid shape.

3. The agitation device according to claim 2, wherein
the plurality of openings is formed such that a horizontal cross section and a vertical cross section of the disk have a plurality of angular cross sections.

4. The agitation device according to claim 1, wherein
the disk has a columnar portion projecting upward.

5. The agitation device according to claim 1, wherein
the agitation member includes a first disk and a second disk disposed to face the first disk, wherein
each of the first disk and the second disk has a plurality of openings to shear the liquid and the gas.

6. The agitation device according to claim 1, wherein
the agitation member includes a first disk and a second disk disposed to face the first disk, wherein
the first disk has a plurality of openings of grid shape defined by a plurality of first straight lines extending in a first direction and a plurality of second straight lines extending in a second direction orthogonal to the first direction to shear the liquid and the gas, wherein
the second disk has a plurality of openings of grid shape defined by a plurality of third straight lines extending in a third direction and a plurality of fourth straight lines extending in a fourth direction orthogonal to the third direction to shear the liquid and the gas, wherein
the plurality of first straight lines and the plurality of third straight lines intersect each other at a predetermined angle in plan view.

7. The agitation device according to claim 6, wherein
the predetermined angle is about 45 degrees.

8. The agitation device according to claim 1, wherein
the agitation member includes a plurality of tiers of disks in up-down direction, wherein
a diameter of an uppermost disk of the plurality of tiers of disks is smaller than a diameter of a lowermost disk portion of the plurality of tiers of disks.

9. The agitation device according to claim 8, wherein
a gap is provided between the plurality of tiers of disks.

10. The agitation device according to claim 1, further comprising:
a case portion forming a conical surface centered on the vertical axis around the agitation member, the conical surface facing the passage and extending upward toward a radial outer side centered on the vertical axis;
a cover portion of a substantially annular shape centered on the vertical axis in plan view, the cover portion covering an upper surface of the disk and having an undersurface formed in recessed shape facing the upper surface of the disk;
an annular flow passage forming portion forming a plurality of annular flow passages concentrically about the vertical axis above the case portion and on the radial outer side of the cover portion; and
a supplying flow passage forming portion forming a supplying flow passage through which the liquid and the gas are supplied to the passage between the disk and the cover portion.
